(19) United States
(12) Patent Application Publication
(10) Pub. No.: US 2007/0110499 A1
(43) Pub. Date: May 17, 2007

(54) Dual-purpose pen for painting

(76) Inventor: Ralph Ricciardi, Totowa, NJ (US)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/280,010

(22) Filed: Nov. 16, 2005

(51) Int. Cl. A47L 1/08; B43K 27/02; B05C 1/00

(52) U.S. Cl. 401/23; 401/19; 401/17

(57) ABSTRACT

A dual-purpose pen for painting comprising a hollow penholder, a watercolor pen, a separator, a crayon, a crayon holder and a crayon cap. Said watercolor pen comprises a tip and a core for storing ink, said tip and said core is connected. Said separator is set inside said penholder and divides it into two sections: one section accommodates the core for storing ink of the watercolor pen and said tip extends out of one end of said penholder; said crayon, which has its end inserted into said crayon holder, and said crayon holder are accommodated inside the other section of said penholder, and said crayon cap is connected to the other end of said penholder, the tip of said crayon extends out of said crayon cap. Compared with the existing technology, the dual-purpose pen for painting in the current invention is featured by: 1. one pen for painting in two effects and easiness to take; 2. low cost.

### FIELD OF INVENTION

This invention is directed to stationery, especially the dual-purpose pen for painting.

### BACKGROUND OF THE INVENTION

When children paint pictures, various pens are needed, such as water color pens, crayons and color pencils, etc. and in order to meet children's needs, parents must prepare all those kinds of pens for them and their pencil boxes are always full.

### SUMMARY OF THE INVENTION

The present invention is aimed to avoid disadvantages mentioned above and to provide a dual-purpose pen with two painting effects.

The technical problems can be solved by the present invention through the following technical plan:

Design and use a dual-purpose pen, which comprises a hollow penholder, a watercolor pen, a separator, a crayon, a crayon holder and a crayon cap; said watercolor pen comprises a pen tip and a core holding ink and said tip is connected to said core holding ink; said separator is set inside the penholder and separates the penholder into two sections: one section holing the watercolor pen, the other end of said tip of which extends out of the other end of said penholder; the other section holding said crayon with its end in said crayon holder while said crayon cap is connected to the other end of said penholder and the tip of said crayon extends out of said crayon cap.

Compared with the existing technology, the dual-purpose pen for painting in the current invention is featured by: 1. one pen for painting in two effects and easiness to take; 2. low cost.

### BRIEF DESCRIPTION OF THE DRAWINGS

FIG. 1 is an exploded view of the current invention;

FIG. 2 is a section view A-A of FIG. 1;

FIG. 3 Is a sketch of one end of the crayon inserts into the crayon holder;

FIG. 4 is a sketch of the crayon and crayon holder insert the screw parts.

### PREFERRED EMBODIMENT

The current invention shall be further described in combination with the attached figures of the preferred embodiment.

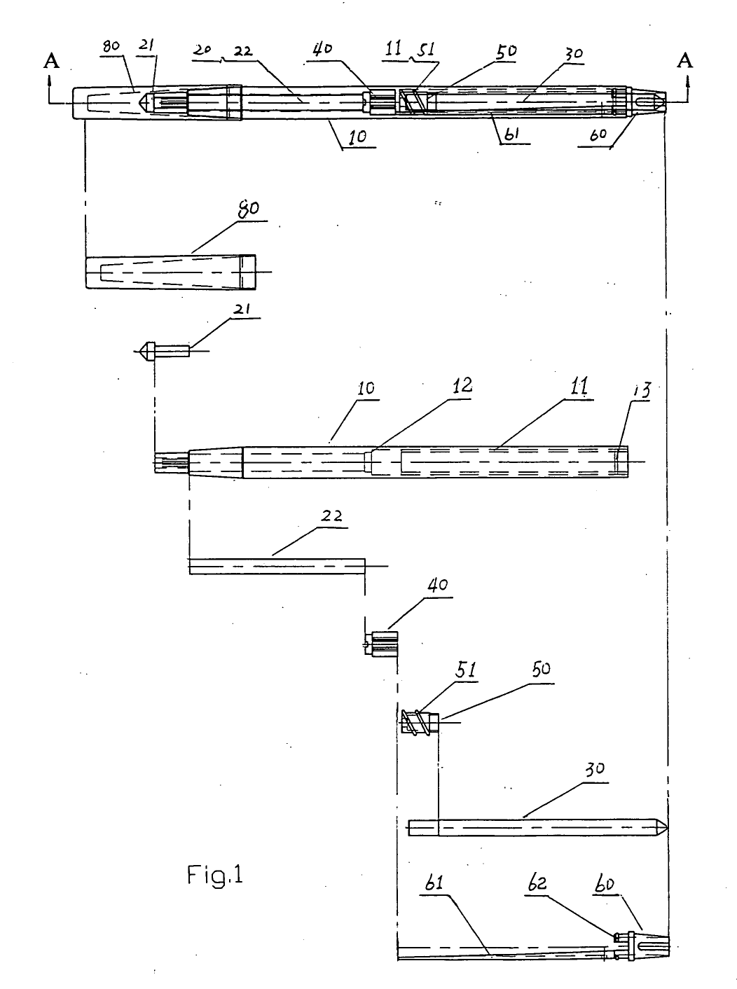

As shown in FIG. 1, the current invention of a dual-purpose pen for painting comprises a hollow penholder 10, a watercolor pen 20, a, separator 40, a crayon 30, a crayon holder 50 and a crayon cap 60; said watercolor pen 20 comprises a pen tip 21 and a core 22 holding ink. Said separator 40 is set inside the penholder 10 and separates the penholder 10 into two sections: one section holing the watercolor pen 20, one end of said tip 21 is connected with said core 22 holding ink and the other end of said tip 21 extends out of the other end of said penholder 10; one end of said crayon 30 is inserted into said crayon holder 50 to be accommodated into the other section of said penholder 10, said crayon cap 50 is connected to the other end of said penholder 10 and the tip of said crayon 30 extends out of said crayon cap 50. In this invention, said crayon 30 can be replaced by a color pencil at the same size.

As shown in FIG. 1, said penholder has a shoulder 11 at the border of the two sections and said separator 40 has a “ [symbol] ” shaped longitudinal section and said separator 40 is anastomotic with said shoulder 11. As shown in FIG. 1, the section of said penholder 10, which accommodates said crayon 30, has interior screw 11 set on its inner wall while said crayon holder 50 has exterior screw 51 on its outer wall to match said interior screw 11; said crayon cap 60 is articulated to the penholder 10 and this crayon holder 60 has a thin and long strip-shaped toggle rod 61 close to the end of the penholder 10. Furthermore, the toggle rod 61 is inserted between said crayon holder 50 and the inner wall of the penholder 10; in case that said crayon cap 60 is turned clockwise or counter-clockwise, said toggle rod 61 will make the crayon holder 50 rotate to move in or out of said penholder 10, thus making said crayon 30 contract into or extend out of the cap 60. As the crayon will become shorter in use owing to wear and loss, the structure of the above mentioned crayon holder 50, crayon cap 60, toggle rod 61 and interior and exterior screws makes it possible to make the crayon extend out of the penholder 10 and cap 60 even it becomes short, thus for full use of crayons. And when the crayon 30 is not in use, it can be contracted into the penholder 10 and cap 60, protecting it effectively from breakage. Besides, if the crayon 30 is substituted by a color pencil, such color pencils can be free from sharpening.

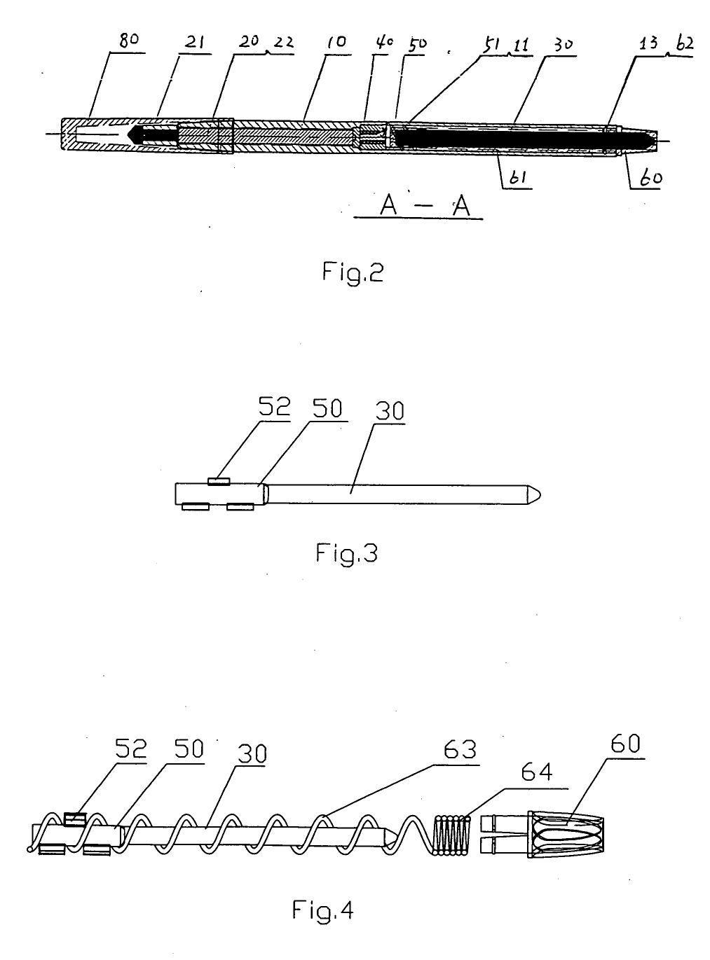

As shown in FIG. 1 and FIG. 2, the articulation method for said crayon cap 60 and penholder 10 in the current invention can be in this way: a ring-shaped groove 12 is set on the inner wall of the penholder 10 close to the exit of the crayon 30 and a positioning projection 62 is set on said crayon cap 60 at the location where it is inserted into the penholder 10 correspondingly, and said positioning projection 62 is inserted into said groove 12.

The tip 21 of the watercolor pen 20 in the current invention is of fibers or cast part and the core 22 of said watercolor pen is made of strong absorbent materials with strong storage ability. Said watercolor pen 20 is also equipped with a cap 80 to protect the watercolor pen 20.

The section of said penholder 10 accommodates said crayon 30 may design or use the other

1. A dual-purpose pen for painting comprising a hollow penholder is characterized by:
it also comprises a watercolor pen, a separator, a crayon, a crayon holder and a crayon cap, and said watercolor pen comprises a tip and a core for storing ink, said tip and said core is connected;
said separator is set inside said penholder and divides it into two sections: one section accommodates the core for storing ink of the watercolor pen and said tip extends out of one end of said penholder; said crayon, which has its end inserted into said crayon holder, and said crayon holder are accommodated inside the other section of said penholder, and said crayon cap is connected to the other end of said penholder, the tip of said crayon extends out of said crayon cap.

2. A dual-purpose pen for painting that is defined in claim 1 is characterized by: said a color pen can substitute crayon.

3. A dual-purpose pen for painting that is defined in claim 1 is characterized by: the section of said penholder that accommodates said crayon has interior screw on its inner wall and said crayon holder has exterior screw on its out wall to match said interior screw; said crayon holder is articulated with the penholder, the crayon cap has a fine and long strip-shaped toggle rod close to the penholder, which is inserted between said crayon holder and the inner wall of the penholder; in case that said crayon cap is turned clockwise or counter-clockwise, said toggle rod will make the crayon holder rotate outward or inward relative to the penholder, thus making said crayon contract into or extends out of the cap.

4. A dual-purpose pen for painting that is defined in claim 1 is characterized by: said penholder has a shoulder at the border of the two sections and said separator, which has a “ [symbol] ” longitudinal section, is anastomotic with said shoulder.

5. A dual-purpose pen for painting that is defined in claim 3 is characterized by: said crayon is articulated with the penholder by means of a ring-shaped groove set on the inner wall of the penholder close to the exit of the crayon and a positioning projection set at the location where said cap is inserted into the penholder, and said positioning projection is inserted into said groove.

6. A dual-purpose pen for painting that is defined in claim 1 is characterized by: the tip of said watercolor pen is of a fiber or cast part.

7. A dual-purpose pen for painting that is defined in claim 1 is characterized by: the core for storing ink of said watercolor pen is made of strong water absorbent material.

8. A dual-purpose pen for painting that is defined in claim 1 is characterized by: said watercolor pen is equipped with a cap.

9. A dual-purpose pen for painting that is defined in claim 1 is characterized by: it also comprises a screw parts, said crayon holder on its out wall to match at least three shoulders; the three shoulders insert separately in the two screws of said screw parts, said crayon holder is articulated with the penholder, the three shoulders touch with inner wall of said penholder; said crayon cap is turned clockwise or counter-clockwise, said three shoulders will rotate outward or inward relative to said screw parts, thus making said crayon contract into or extends out of the cap.
